(19) United States
(12) Patent Application Publication
(10) Pub. No.: US 2025/0291228 A1
(43) Pub. Date: Sep. 18, 2025

(54) OPTICAL SWITCH WITH RING RESONATOR PHOTONIC DEVICES

(71) Applicant: Xscape Photonics Inc., Fort Lee, NJ (US)

(72) Inventors: Karthik Vaithianathan, New York, NY (US); Vivek Raghunathan, Mountain View, CA (US); Keren Bergman, New York, NY (US); Asher Novick, Long Island City, NY (US)

(21) Appl. No.: 19/077,950

(22) Filed: Mar. 12, 2025

Related U.S. Application Data
(60) Provisional application No. 63/564,326, filed on Mar. 12, 2024.
(60) Provisional application No. 63/727,117, filed on Dec. 2, 2024.

(51) Int. Cl. G02F 1/313; G02F 1/31

(52) U.S. Cl. CPC G02F 1/313; G02F 1/311; G02F 2201/02; G02F 2203/15; G02F 2203/70

(57) ABSTRACT

An integrated photonic device independently directs each channel of a multiplexed input optical signal received from a corresponding one of N input port to one of N output ports, each multiplexed input optical signal including N channels. The device includes: N input waveguides; secondary waveguides; wavelength-selective filters, each: i) including a ring resonator, ii) being optically coupled to a corresponding one of the N input waveguides and a corresponding one of the secondary waveguides, and iii) being switchable between a first state in which an optical signal in a corresponding one of the N channels is coupled from the corresponding input waveguide into the corresponding secondary waveguide and a second state in which the optical signal in the corresponding one of the N channels is not coupled into the corresponding secondary waveguide; N multi-wavelength mixers; and N output waveguides.

### CROSS-REFERENCE TO RELATED PATENT APPLICATIONS

This application claims the benefit of U.S. Provisional Application No. 63/564,326, filed Mar. 12, 2024 and U.S. Provisional Application No. 63/727,117, filed Dec. 2, 2024, the contents of which are incorporated by reference herein.

### BACKGROUND

Silicon photonics devices utilize silicon as an optical medium, and semiconductor fabrication techniques for patterning the devices can achieve sub-micron precision. Because silicon is used as a substrate for most integrated circuits, silicon photonic devices can be hybrid devices that integrate both optical and electronic components onto a single microchip. Silicon photonic devices can also be used to facilitate data transfer between microprocessors, a capability of increasing importance in modern networked computing.

### SUMMARY

Integrated photonic devices utilizing ring resonators for optical filters are described. The architectures described are versatile and scalable and enable integrated devices such as switches capable of efficiently providing multiple modulated optical signals across frequency bands commonly used in conventional optical communication systems. The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic of an example of an integrated photonic device based on wavelength-selective filters.

FIG. 2A is a schematic of an example of an add/drop filter based on a ring resonator.

FIG. 2B is a schematic of another example of an add/drop filter based on a ring resonator.

FIG. 3 is a cross-sectional view of the add/drop filter from FIG. 2A.

FIGS. 4A and 4B are schematics of another example of an integrated photonic device based on wavelength-selective filters.

FIG. 4C is an example of a channel mixer from the integrated photonic device of FIGS. 4A and 4B.

FIGS. 5A, 5B, and 5C depict an example of a switch incorporating the integrated photonic devices of FIGS. 1, 4A, and 4B.

FIG. 6A depicts a logical layout of an example of a switch incorporating the integrated photonic devices of FIGS. 1, 4A, and 4B.

FIG. 6B depicts a logical layout of an example of a switch incorporating the integrated photonic devices of FIGS. 1, 4A, and 4B.

FIG. 7A depicts a logical layout of an example of a switch incorporating the integrated photonic devices of FIGS. 1, 4A, and 4B.

FIG. 7B depicts a logical layout of an example of a switch incorporating the integrated photonic devices of FIGS. 1, 4A, and 4B.

FIG. 8 depicts an example of a device incorporating a switch and a wavelength offset detector.

FIG. 9 depicts an example of a subsystem including multiple devices, such as the device of FIG. 8.

Like reference numbers and designations in the various drawings indicate like elements.

### DETAILED DESCRIPTION

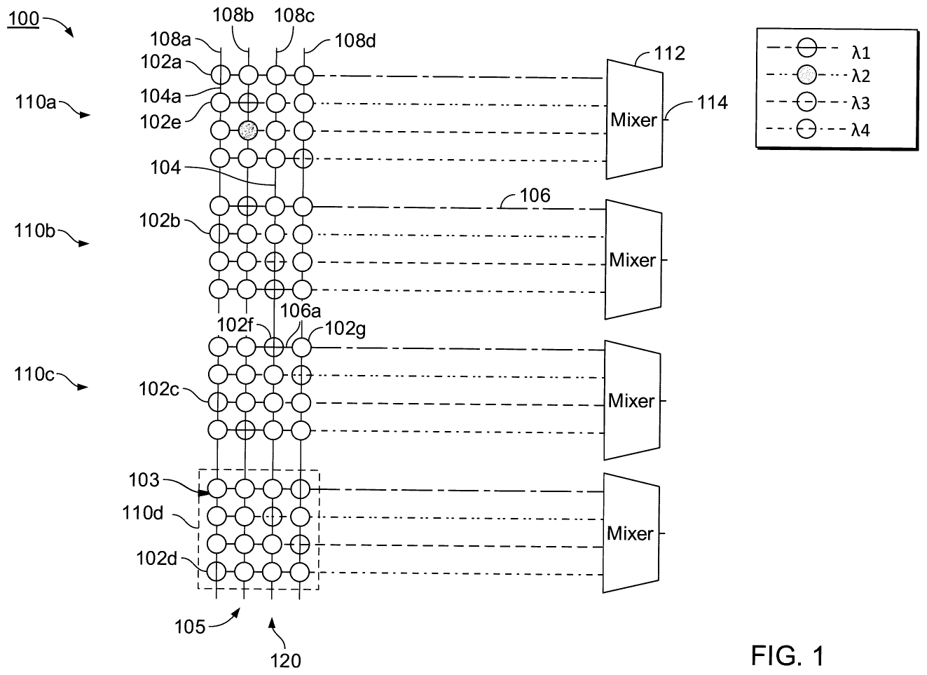

With reference to FIG. 1, an example integrated photonic device 100 based on wavelength-selective filters includes filters 102, input waveguides 104, secondary waveguides 106, input ports 108, multi-wavelength mixers 112, and output waveguides 114. A filtering mechanism of the integrated photonic device 100 is based on the operation of the filters 102. The integrated photonic device 100 is a switch, e.g., the filters 102 route, based on a wavelength of an optical signal, the optical signal from an input port 108 to one or more of the output waveguides 114. For example, the input ports 108 receive multiple-wavelength multiplexed signals, and the integrated photonic device 100 selectively and independently delivers each multiplexed signal to one of the four output waveguides 114.

The filters 102 are arranged in filter arrays 110 (see dotted rectangle around filter array 110d in FIG. 1). Topologically, each filter array, e.g., filter arrays 110a, 110b, 110c, and 110d, is a two-dimensional array, e.g., includes columns 105 and rows 103. In this example, there are as many channels as there are rows and columns in each filter array 110, e.g., there are four channels and four rows and columns in each filter array 110.

The input ports 108 receive multiplexed input optical signals having multiple channels, e.g., N multiplexed input optical signals each having N channels. The input ports 108 are coupled to the input waveguides 104, which transmit the optical signals to the top row in the filter array 110a.

Waveguides connect filters 102 in adjacent columns 105 and rows 103. For example, input waveguides 104 correspond to the columns 105, e.g., input waveguide 104a connects filters 102a and 102e, which are in the same column and adjacent rows. As another example, secondary waveguides 106 correspond to the rows 103, e.g., secondary waveguide 106a connects filters 102f and 102g, which are in the same row and adjacent columns.

Within each filter array 110, each row 103 includes one filter 102 configured to filter optical signals from a different channel, e.g., redirect an optical signal to a neighboring column 105 if the optical signal has a particular peak wavelength, e.g., is within a particular wavelength range, or direct the optical signal to a neighboring row 103 if the optical signal is outside a particular wavelength range. In this specification, “filtering” refers to coupling an optical signal from one waveguide into another waveguide via a filter 102. In some implementations, there is no more than one filter 102 in each row 103 configured to filter optical signals within a particular wavelength range, and each filter 102 is configured to filter optical signals in a different wavelength range. For example, if there are N (a positive natural number) input ports 108, there are N−1 filters in each row configured to not filter light, e.g., optical signals, within a particular wavelength range or at least any ranges including wavelengths of the N channels.

In some implementations, there are as many input ports, e.g., four input ports 108a, 108b, 108c, and 108d, as there are channels supported by the device 100. For example, in filter array 110a, the first row, e.g., the top row, includes one filter 102a, configured to filter optical signals with a first peak wavelength, e.g., a “λ1” channel, and three filters configured to not filter optical signals with a particular peak wavelength. The second row includes one filter configured to filter optical signals at a second peak wavelength, e.g., a “λ2” channel, and three filters configured to not filter optical signals with a particular peak wavelength. The third row includes one filter configured to filter optical signal with a third peak wavelength, e.g., a “λ3” channel, and three filters configured to not filter optical signals with a particular peak wavelength. The fourth row includes one filter configured to filter optical signals with a fourth peak wavelength, e.g., a “λ4” channel, and three filters configured to not filter optical signals with a particular peak wavelength.

In some implementations, a single column of a filter array 110 can have more than one filter 102 configured to filter light with different peak wavelengths. For example, filter array 110d includes a filter (in the first row and fourth column) configured to filter the λ1 channel and another filter (in the third row and fourth column) configured to filter the λ3 channel. In some implementations, a filter array can have no filters 102 configured to filter optical signals with a particular peak wavelength in a single column. For example, the fourth column in filter array 110b does not include any filter arrays that are configured to filter light with a particular peak wavelength.

Neighboring filter arrays 110 are connected by the input waveguides 104. For example, four input waveguides 104 connect the bottom row of filter array 110a to the top row of filter array 110b. A super array 120 includes the filter arrays 110 stacked on top of each other, e.g., the four filter arrays 110a-d, which are each 4×4 arrays, form the super array 120, which is a 16×4 array. Within each column 105 of the super array 120, there is one filter 102 configured to filter optical signals with each of the peak wavelengths of the N channels, e.g., four filters 102 configured to filter optical signals in total. The four filters 102, e.g., filters 102a, 102b, 102c, and 102d that are each configured to filter different channel are connected serially within a single column 105 of the super array 120. Accordingly, the input waveguides 104 can transmit multiplexed input optical signals to each of the serially arranged filters 102a, 102b, 102c, and 102d in the leftmost column 105.

Although FIG. 1 depicts the filters 102 disposed in an equally spaced grid, the filters 102 can be physically disposed in other arrangements. The terms “columns” and “rows” refer to connections between the filters 102, e.g., being coupled to adjacent filters in an array, rather require than exact locations. For example, the length of waveguide sections, e.g., the columns of input waveguides 104 and rows of secondary waveguides 106, between each filter 102 can vary.

Although FIG. 1 depicts each filter array 110 having a similar channel organization, e.g., the first row 103 of each filter array 110 includes a filter 102 configured to filter the λ1 channel, other configurations are possible. For example, the order of the rows can vary.

In the last column 105 of each filter array 110, e.g., the rightmost column in this example, the secondary waveguides 106 connect the filters 102 to a multi-wavelength mixer 112. Each filter array 110 corresponds to a respective multi-wavelength mixer 112, e.g., the filter arrays 110 couple the input waveguides 104 to a corresponding multi-wavelength mixer 112 via four of the secondary waveguides 106. The multi-wavelength mixer 112 is configured to receive and combine multiple optical signals of different wavelengths into a multiplexed output optical signal. Each multi-wavelength mixer 112 is coupled to an output waveguide 114, e.g., there is one multi-wavelength mixer 112 and output waveguide 114 per channel. In some implementations, the multi-wavelength mixer 112 is a passive silicon photonics component, e.g., an arrayed waveguide grating (AWG), a Mach-Zehnder interferometer (MZI), or a ring-based resonator.

Whether a filter 102 is configured to filter or not filter light with a particular peak wavelength depends on a state of the filter. For example, in a first state, a filter 102 can be configured to filter an optical signal with a peak wavelength, e.g., couple the optical signal from a corresponding input waveguide 104 to a corresponding secondary waveguide 106 based on the wavelength of the optical signal. In a second state, the filter 102 can be configured to not filter an optical signal with a peak wavelength, e.g., not couple the optical signal from a corresponding input waveguide 104 to a corresponding waveguide 106. In other words, when the filter 102 is configured to not filter an optical signal, the optical signal remains in a single column as the optical signal travels through the super array 120. When the filter 102 is configured to filter an optical signal, the optical signal travels from one column to another and eventually to a corresponding mixer 112.

In the example of FIG. 1, the device 100 is a four-ported switch, e.g., has four input ports 108, with four channels at each port 108. To achieve the ability to route an optical signal from any input port 108 to any output waveguide 114, there are N³=4³=64 filters 102. For a 16-ported switch, there are 16³=4096 filters, and for a 64-ported switch, there are 262,144 filters. Compared to conventional four-channel switches with the ability to route the signal from any input port to any output port, 64 is a relatively low number for the number of required filters. Similarly, 4096 and 262,144 filters is a relatively low number for 16- and 64-ported switches.

Advantageously, the integrated photonic device 100 has varied capabilities. Based on the states of the filters 102 in the super array 120, optical signals from any channel input at the input port 108 can be routed to any output waveguide 114, which is not possible in a conventional switch. For example, if an input port 108 receives a multiplexed signal including four optical signals each encoded with the same data but in different channels, the multiplexed signal can be broadcast to all four of the output waveguides 114 at the same time. As another example, an entire multiplexed signal, e.g., a signal including 4, 16, or 64 channels, can be directed to a single output waveguide 114.

The device 100 can be configured to operate in three different modes, e.g., a first mode supporting 16 channels, a second mode supporting 32 channels, and a third mode supporting 64 channels. This flexibility in operation, e.g., switching between modes based on programming, is another advantage of the device 100. The number of supported channels can affect the spacing between wavelengths. For example, at 16 channels, the device 100 can support a wavelength spacing of 200 GHz, giving a per wavelength maximum bandwidth of 400 Gbps for non-return-to-zero (NRZ) modulation and 800 Gbps for pulse amplitude modulation 4-level (PAM4) modulation. At 32 wavelengths, the device 100 can support a wavelength spacing of 100 GHz, giving a per wavelength maximum bandwidth of 200 Gbps for NRZ modulation and 400 Gbps for PAM4 modulation. At 64 wavelengths, the device 100 can support 50 GHz spacing, giving a per wavelength maximum bandwidth of 100 Gbps for NRZ modulation and 200 Gbps for PAM4 modulation.

The throughput of the device 100 depends on the coding scheme, e.g., NRZ or PAM4. For example, when using NRZ modulation, each wavelength is modulated at 100 Gbps, and each wavelength is modulated at 200 Gbps when using PAM4 modulation. In some implementations, the input ports 108 are fibers that have a total bandwidth supporting 64 wavelengths, which means that for PAM4 modulation, each input port has a throughput of 64×200 Gbps=12.8 Tbps. Since there can be 64 channels per input port 108, the total device 100 can have a bandwidth of 819.2 Tbps, which is on the order of 1 Pbps.

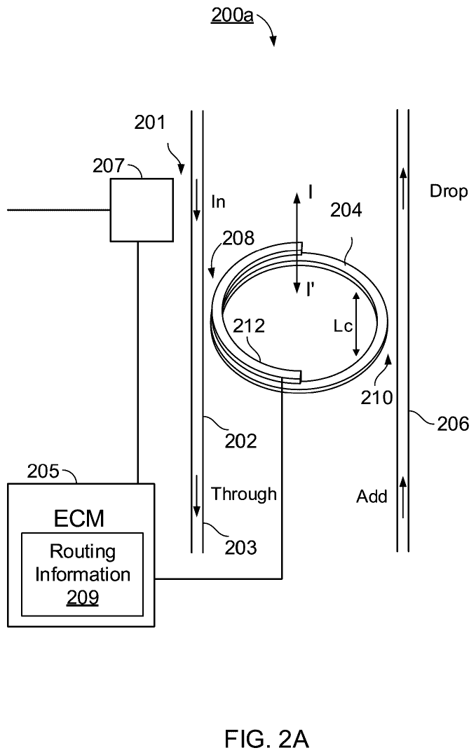

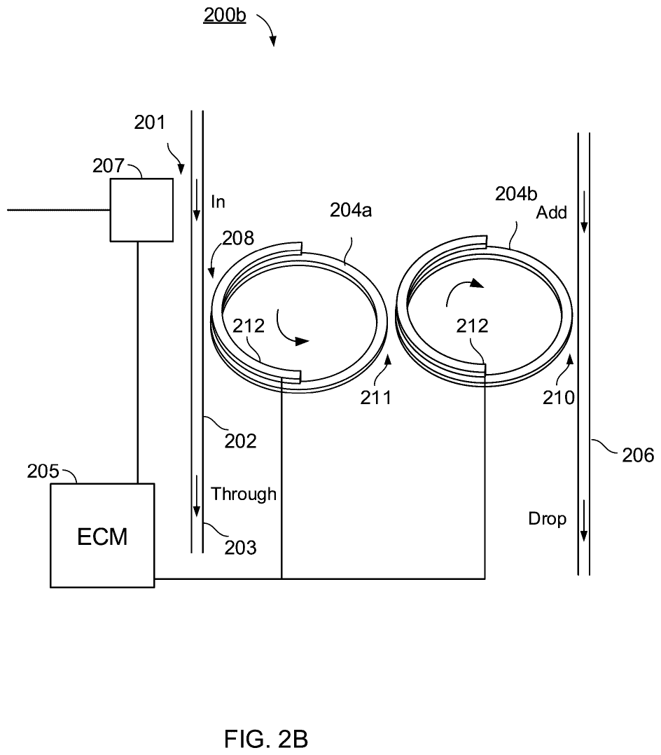

An electronic control module (depicted in FIG. 2A and described below) controls the states of the optical filters 102 in a variety of ways, depending on the mode operation of the optical filters. For example, the electronic control module can send instructions to heaters that control a temperature of the optical filters 102, which affects the state of the filters 102. In some implementations, each of the filters 102 can be “tuned” to either filter or not filter optical signals in each channel supported by the device 100. By tuning the filters 102, the device 100 operates to couple an optical signal in a wavelength channel from one waveguide into another waveguide or transmit the optical signal. The description accompanying FIG. 2A will provide more details as to the tuning of the optical states of the optical filters 102.

The filters 102 of FIG. 1 can be the add-drop, resonant filters. In some implementations, the filters 102 include ring resonators, e.g., micro ring resonators (MRR) that either “add” or “drop” an optical signal from a waveguide. With reference to FIG. 2A, an add-drop filter 200a includes an input waveguide 202, a ring resonator 204, and a secondary waveguide 206. For example, the filters 102 of FIG. 1 can be the add-drop filter 200a, add-drop filter 200b, or a combination thereof.

An optical source 207 emits an optical signal that couples into the input waveguide 202 through an input port 201. The optical signal travels through the input waveguide 202 and toward a region where the input waveguide 202 is proximate to the ring resonator 204.

Light can travel from one waveguide to another when the waveguides are coupled. Placing the ring resonator 204 proximate to the input waveguide 202 provides a coupling region 208. The coupling region 208 is a region where the input waveguide 202 and the ring resonator 204 are sufficiently close to allow an optical signal traveling in the input waveguide 202 to enter the ring resonator 204, e.g., evanescent coupling, and vice versa. Similarly, placing the ring resonator 204 proximate to the secondary waveguide 206 provides the coupling region 210, where optical signals can travel from the ring resonator 204 to the secondary waveguide 206 and vice versa.

Input light can travel into the add-drop filter 200a at the input port 201. Due to a coupling region 208 between the input waveguide 202 and the ring resonator 204 and depending on the wavelength, some of the light enters the ring resonator 204 on the left side of the ring resonator 204. The rest of the light continues to travel through the input waveguide 202. The signal in the ring resonator 204 can travel in a counterclockwise direction until it reaches the other coupling region 210.

At the coupling region 210, depending on the wavelength, some of the light is “dropped,” e.g., exits the ring resonator 204. In some implementations, light is “added” to the ring resonator 204 through an additional port in the secondary waveguide 206. Light added at the additional port travels in the opposite direction through the secondary waveguide 206 compared to light that entered through an input port in the input waveguide 202, because light that is coupled into the ring resonator 204 on the right side of the ring resonator 204 also travels in a counterclockwise direction toward coupling region 208. Then, the “added” light can decouple from the ring resonator 204 and enter the input waveguide 202 through coupling region 208. Both “added” light and light that never entered the ring resonator 204 and just passed through the input waveguide 202 can exit the add-drop filter 200a at an exit port 203.

As an example, when filter 102 is the add-drop filter 200a, optical signals that are filtered can be added to a filter through coupling from input waveguides 104 (input waveguide 202) to the filter 102 and dropped by coupling from the filter 102 to secondary waveguide 106 (secondary waveguide 206). Optical signals that are not filtered can remain in the input waveguide 104 (input waveguide 202) without coupling into the filter 102.

The size, e.g., radius, of the add-drop filter 200a can determine the resonant frequency of the filter. For example, when the circumference of the ring resonator is an integer multiple of a wavelength of light, those wavelengths of light will interfere constructively in the ring resonator 204, and the power of those wavelengths of light can grow as the light travels through the ring resonator 204. When the circumference of the ring resonator is not an integer multiple of the wavelengths of light, those wavelengths of light will interfere destructively in the ring resonator 204, and the power of those wavelengths will not build up in the ring resonator 204. In some implementations, the radius of the ring resonator 204 is in a range of 50 microns to 200 microns.

Thermal tuning can be used to select which frequencies are added or dropped. For example, the add/drop resonant filter can include a heating element 212, which is thermally coupled to the ring resonator 204. For example, changing the temperature of the ring resonator 204 can increase the resonant frequency. An electronic control module (ECM) 205 is in communication with the optical source 207 and the heating element 212 to control the state of the add/drop filter 200a, e.g., whether it is tuned to filter or not filter light with a particular peak wavelength. The ECM 205 communicates with the optical source 207 and the heating element 212 by sending electronic signals, e.g., routing information 209. For example, the routing information 209 includes instructions to activate individual filters 102 or maintain inactivated states. When activated, a filter 102 is configured to couple an optical signal from an input waveguide 104 to a secondary waveguide 106 (filtering). When inactivated, a filter 102 is configured to couple an optical signal from an input waveguide 104 to another input waveguide (not filtering).

The heating element 212 is disposed on top of the ring resonator 204. The heating element 212 has a shape that at least partially matches a shape of the ring resonator 204. For example, the heating element 212 can be a semicircle, as depicted in FIG. 2A. The heating element 212 applies heat to the ring resonator 204 by supplying an electric current. The routing information 209 includes instructions for the heating element 212 to control what wavelengths of optical signals are filtered based on the resonant wavelength of the optical filter, which is temperature dependent. The ECM 205 can update the routing information 209, e.g., provide new routing information 209, to the heating element 212 to change a state of the filter 102, e.g., change which channels are filtered. In some implementations, the ECM 205 can update the routing information on intervals on the scale of microseconds. Although this example includes a heating element 212, cooling elements or general temperature control elements are possible.

The optical source 207, e.g., a pump source, is a laser, such as a single-frequency continuous-wave pump laser. The optical source 207 can be a programmable laser that generates equally spaced pulses in frequency space. The optical source 207 can be coupled to the add/drop filter 200a through a fiber. In some implementations, the coupling includes a lens coupling, butt-coupling, or monolithic integration of the laser.

The coupling strengths at coupling regions 208 and 210 can determine how much of light within the ring resonator 204 couples into or out of the ring resonator 204. For example, the coupling strength can be selected to permit a steady state to build up within the ring resonator 204 by in-coupling and out-coupling a predetermined percentage of light at specific wavelengths. The coupling strengths at the coupling regions 208 and 210 can depend on the material and geometrical parameters of the add-drop filter 200a. The wavelength dependence on light's behavior at the coupling regions 208 and 210, e.g., whether light enters or exits the ring resonator also depends on the material and geometrical parameters of the add-drop filter 200a.

In some implementations, the add/drop filter can be a higher-order resonant filter. The order of the resonator is the number of ring resonators between the first and second waveguide. For example, FIG. 2B depicts a second order add-drop filter 200b, which includes two ring resonators 204. The add-drop filter 200b includes many of the same components as add-drop filter 200a of FIG. 2A, and repeated description of these components is omitted. In some implementations, a higher-order resonant filter can be more efficient, e.g., cause less loss, than a first-order resonant filter.

In addition to the coupling 208 between the input waveguide 202 and the first ring resonator 204a and the coupling region 210 between the secondary waveguide 206 and the second ring resonator 204b, there is also a coupling 211 between the first and second ring resonators 204a and 204b. Due to this coupling, an optical signal traveling in counter-clockwise direction in the first ring resonator 204a enters the second ring resonator 204b and travels in a clockwise direction. Similarly, an optical signal traveling in clockwise direction in the second ring resonator 204b enters the first ring resonator 204a and travels in a counterclockwise direction. Accordingly, the path of an optical signal from the input waveguide 202 to secondary waveguide 206 and vice versa can follow an S-shaped path.

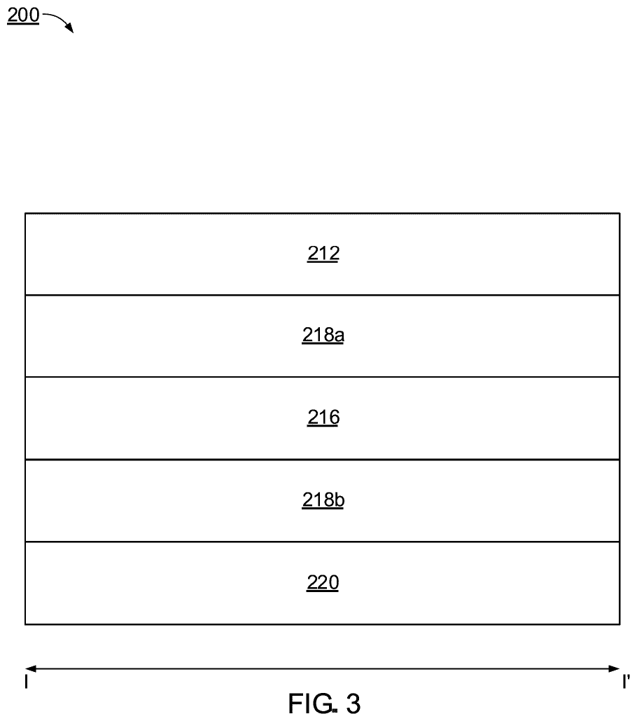

In some implementations, the ring resonators 204 have different geometries than those presented in FIGS. 2A and 2B. For example, the ring resonators can have elliptical shapes or other geometries. More details on ring resonators can be found in U.S. application Ser. No. 18/460,477, which is hereby incorporated by reference. The cross-sectional view in FIG. 3 is along the line I-I′ in FIG. 2A. In this example, the ring resonator 204 includes a core layer 216, which can be a patterned waveguide. The core layer 216 is clad with dielectric layers 218a and 218b. A substrate 220 can be in contact with the dielectric layer 218b and support the core layer 216 and dielectric layers 218a and 218b. Heating element 212 can be disposed on top of dielectric layer 218a. The add/drop filters 200a and 200b can be fabricated in a manner compatible with conventional foundry fabrication processes.

The materials making up add/drop filters 200a and 200b can vary. Each of the input waveguide 202, the ring resonator 204, and the secondary waveguide 206 can include a nonlinear optical material, such as silicon, silicon nitride, aluminum nitride, lithium niobate, germanium, diamond, silicon carbide, silicon dioxide, glass, amorphous silicon, silicon-on-sapphire, or a combination thereof. In some implementations, the core layer 216 is silicon nitride with patterned doping. In some implementations, the dielectric layers 218a and 218b include silicon dioxide.

In some implementations, the heating element 212 includes metal. In some implementations, the heating element 212 is a resistive heater formed in the core layer 216, e.g., carrier-doped silicon. In some implementations, the heating element 212 is generally disposed adjacent, e.g., next to, below, in contact with, to the ring resonator 204. In some instances, the resonator resonance tuning can be done with other approaches, such as the electro-optic effect, free-carrier injection, or microelectromechanical actuation.

In some implementations, various elements of the device, e.g., the input waveguide 202, the ring resonator 204, the secondary waveguide 206, and the heating element 212 are integrated onto a common photonic integrated circuit by fabricating all the elements on the substrate 220.

The strength of the couplings in the coupling regions 208 and 210 depend on various factors, such as a distance between the input waveguide 202 and the ring resonator 204 and the distance between the ring resonator 204 and the secondary waveguide 206, respectively. The radius of curvature, the material, and the refractive index of the ring resonator 204 can also impact the coupling strength. Reducing the distance between the heating element 212 and the core layer 216 can increase the thermo-optic tuning efficiency. For example, 0.1% or more of light (e.g., 1% or more, 2% or more, such as up to 10% or less, up to 8% or less, up to 5% or less) can be incoupled into the ring resonator 204, the secondary waveguide 206, and the input waveguide 202.

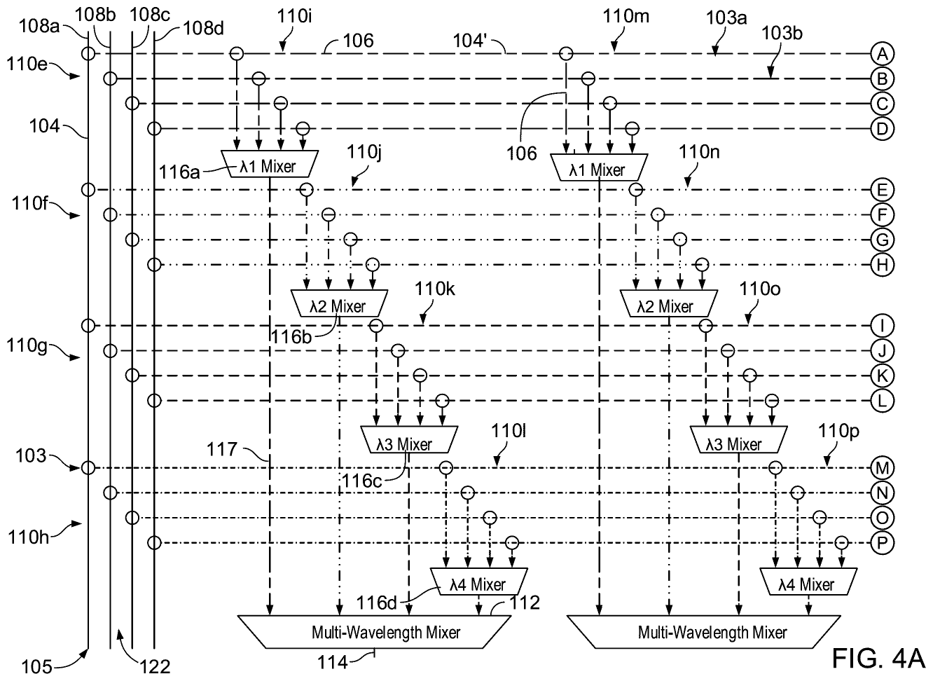

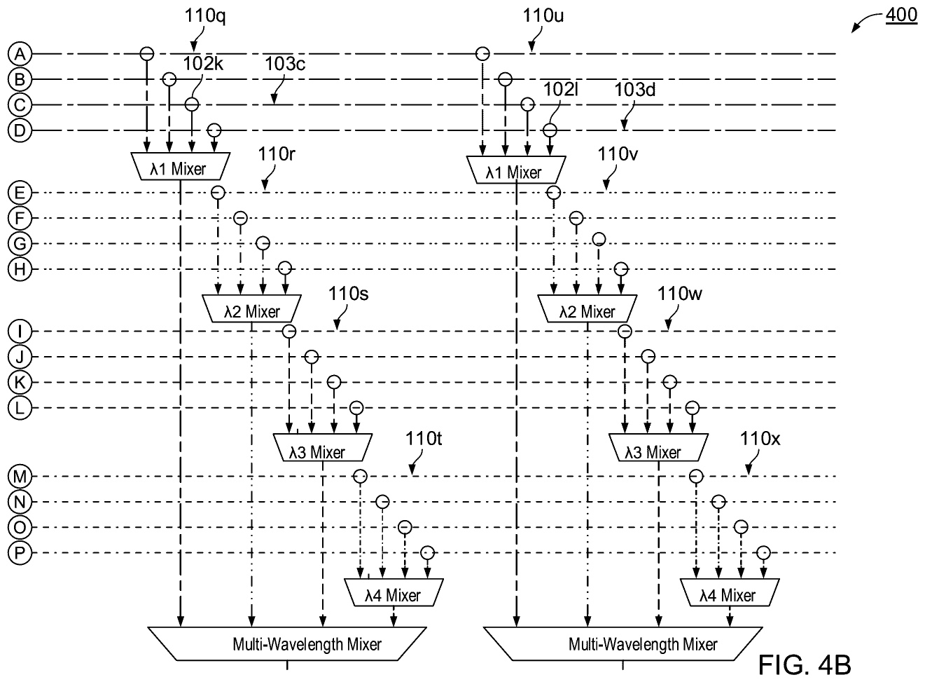

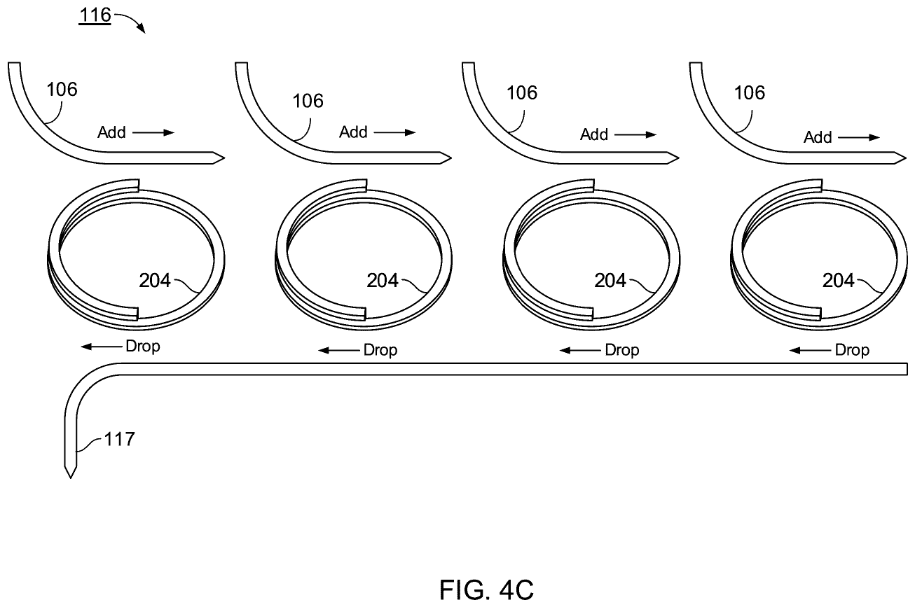

With reference to FIGS. 4A and 4B, an integrated photonic device 400 based on wavelength-selective filters includes filters 102 arranged in filter arrays 110, input waveguides 104, secondary waveguides 106, input ports 108, multi-wavelength mixers 112, output waveguides 114, and channel mixers 116. FIGS. 4A and 4B show different portions of integrated photonic device 400 and connect at the points labelled A, B, C, D, E, F, G, H, I, J, K, L, M, N, O, and P.

Compared to the integrated photonic device 100 of FIG. 1, the filters 102 in the filter arrays 110 are grouped by the peak wavelengths associated with the filters. For example, filter arrays 110e, 110f, 110g, and 110h can be referred to as first filter arrays, since for each channel, these are the first filter arrays that will filter an optical signal coming from the input ports 108 for each channel. In this example, for four channels, the filters 102 are arranged in N²+N=4²+4=20 filter arrays 110.

Each filter 102 in the first filter arrays 110e-110h it is configured to filter an optical signal with a particular peak wavelength. For example, each filter 102 in first filter array 110e is configured to filter optical signals in the λ1 channel and pass optical signals in the λ2, λ3, and λ4 channels. Each filter 102 in the first filter array 110f is configured to filter optical signals in the λ2 channel and pass optical signals in the red, λ3, and λ4 channels, and so on. Similarly to the configuration in FIG. 1, each column 105 includes exactly one filter 102 per channel configured to filter optical signals within that channel.

Compared to FIG. 1, instead of being depicted as a matrix, the filter arrays 110 are depicted as diagonal arrays. The input waveguides 104 are arranged in columns 105 for the first filter arrays 110e-110h and connect the filters 102 in a super array 122 that includes the first filter arrays 110e-110h. Secondary waveguides 106 connect the first filter arrays 110e-110h to the remaining filter arrays. Input waveguides 104′ and secondary waveguides 106 couple the remaining filter arrays, e.g., connecting filters 102 in second filter arrays 110i, 110j, 110k, and 110l to filters 102 in third filter arrays 110m, 110n, 110o, and 110p. The input waveguides 104′ can be coupled to the secondary waveguides 106 or form a continuous waveguide.

Within each second filter array 110i-110l, one filter 102 is configured to filter wavelengths with the same peak wavelength as in the corresponding first filter array 110e-110h. For example, in second filter array 110i, filter 102h is configured to filter optical signals in a λ1 channel, while the remaining filters 102, e.g., N−1=4−1=3 filters, in filter array 110i are configured to not filter optical signals in any channel, and all the filters 102 in filter array 110e are configured to filter optical signals in the λ1 channel. Similarly, within the third filter arrays 110m, 110n, 110o, and 110p, the fourth filter arrays 110q, 110r, 110s, and 110t, and fifth filter arrays 110u, 110v, 110w, and 110x, one, e.g., no more than one, filter 102 is configured to filter wavelengths in the same wavelength as in the corresponding first filter array 110e-110h.

Which filters within the second, third, and fourth filter arrays 110l-10x are tuned to filter optical signals with a particular peak wavelength can be selected such that one and no more than one row 103 corresponding to each channel has a filter 102 configured to filter an optical signal for the respective channel. For example, for the λ1 channel, a filter 102i configured to filter optical signals in the λ1 channel is in the first, e.g., topmost, row 103a, a filter 102j configured to filter optical signals in the λ1 channel is in the second row 103b, a filter 102k configured to filter optical signals in the λ1 channel is in the third row 103c, and a filter 102l configured to filter optical signals in the λ1 channel is in the fourth row 103d. The same pattern applies to the remaining channels, although the order of which row has a filter configured to filter optical signals that a particular peak wavelength varies.

Each row, e.g., rows 103a-103d, connects N+1, e.g., 5 in this example, filters 102. Each row includes two, e.g., exactly two, filters in a first state where the filter is configured to filter optical signals in one channel, e.g., row 103a includes a filter 102 in the first filter array 110e and a second filter 102i in the second array 110i.

Each of the second, third, fourth, and fifth filter arrays 110i-110x is connected to a corresponding channel mixer 116. For example, the four filters 102 in second filter array 110i all feed, via secondary waveguides 106, into a channel mixer 116a (e.g., “λ1 mixer”), which is configured to combine signals in the λ1 channel. Since each of the filters 102 in the second, third, fourth, and fifth filter arrays 110i-110x can be tuned to either filter or not filter optical signals with a corresponding peak wavelength, the channel mixers 116 collect optical signals from the filters 102 tuned to filter optical signals no matter which filter 102 happens to be “on” for a given configuration.

Each of the channel mixers 116 feeds into a corresponding multi-wavelength mixer 112 via waveguides 117, such that each multi-wavelength mixer 112 receives optical signals from each channel. In this example, there are four channels, e.g., λ1, λ2, λ3, and λ4, and four channel mixers 116a, 116b (e.g., “λ2 mixer”), 116c (e.g., “λ3 mixer,”), and 116d (e.g., “λ4 mixer) feed into a single multi-wavelength mixer 112.

In some implementations, the channel mixers 116 are ring mixers. With reference to FIG. 4C, an example of a channel mixer 116 includes four ring resonators 204. Each ring resonator 2024 is coupled to a respective secondary waveguide 106, each of which is coupled to a filter 102 from a corresponding filter array 110. For example, the channel mixer of FIG. 4C is channel mixer 116a, and the four secondary waveguides 106 are the secondary waveguides 106 coupled to the filters 102 from filter array 110i.

The ring resonators 204 can be configured to in-couple optical signals traveling from the secondary waveguides 106, e.g., “add” those optical signals, and out-couple the optical signals into the waveguide 117, e.g., “drop” those signals. In some implementations, only one ring resonator 204 within the channel mixer 116 is configured to add/drop optical signals in a corresponding channel to reduce the likelihood of interference from neighboring ring resonators 204.

In the arrangement of FIGS. 4A and 4B, the filters 102 are arranged by their wavelength selectivity. For example, the first N (N being the number of channels, e.g., 4 in this example) rows only include filters 102 tuned to either filter optical signals in the λ1 channel or not filter any optical signals. Arranging the filters 102 according to their wavelength selectivity can advantageously reduce interference from optical signals with other peak wavelengths. This reduction in interference can make this arrangement suitable for scaling up the device 400 to include a higher number of ports, e.g., 16 or 64.

This arrangement separates the filters 102 according to the wavelength selectivity by having each filter 102 in the first filter arrays 110e-110h filter a corresponding peak wavelength. As a result, compared to the arrangement in FIG. 1, there are more filters 102 to achieve the ability of directing an optical signal from any input port 108 to any output waveguide 114. In this example, there are four channels, so there are N³+N²=4³+4²=80 filters 102. Accordingly, for an N-channel device 100, there will be N² more filters in an arrangement like that in FIGS. 4A and 4B compared to the photonic device 100 in FIG. 1.

Optical signals that pass through filters 102 can experience loss even if the filters are not configured to filter signals at the signal wavelength. Additional filters can compound this loss. Accordingly, for the same switch radix value, device 400 can have higher loss than photonic device 100. In some implementations, the insertion loss in a device can scale quadratically or linearly. For example, in the arrangement of FIG. 1, there are N³=4³=64 filters 102, since there are four channels. For the same switch radix of 4, in the arrangement of FIGS. 4A and 4B, there are N³+N²=4³+4²=80 filters 102. Accordingly, the loss in device 400 is greater than the loss in device 100 though the two devices have the same switch radix.

Although not depicted for the sake of simplicity in the figures, each of the filters 102 in FIGS. 1, 4A, and 4B can include a heater or some other component for controlling a temperature of the filter, the heater or other component being connected to an electronic control module.

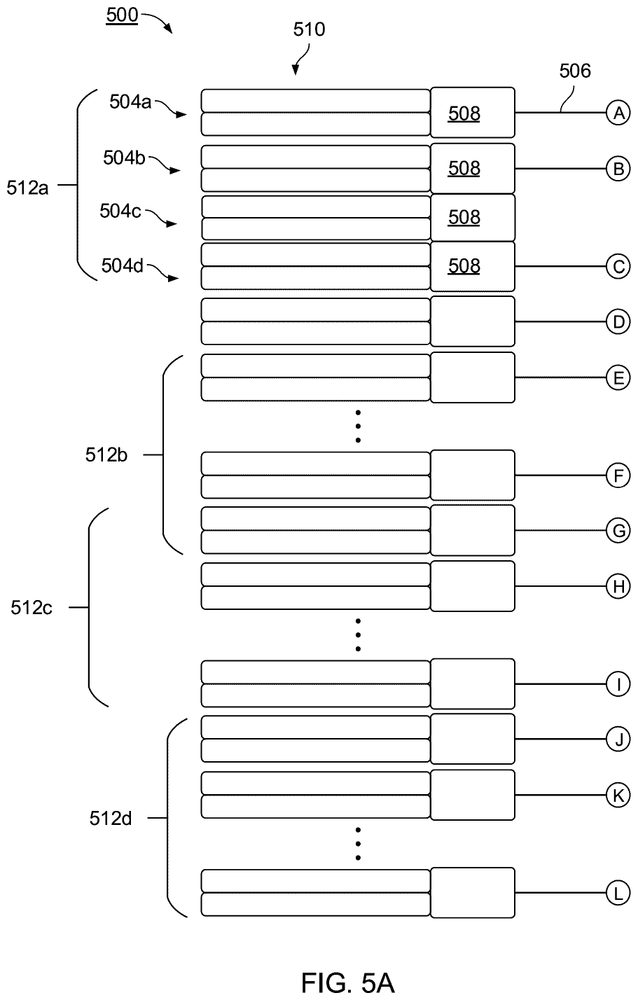

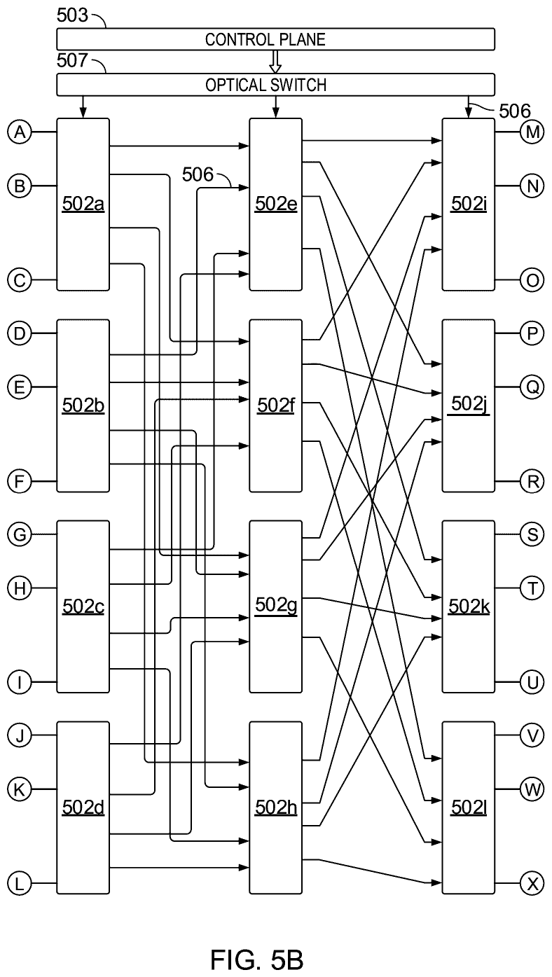

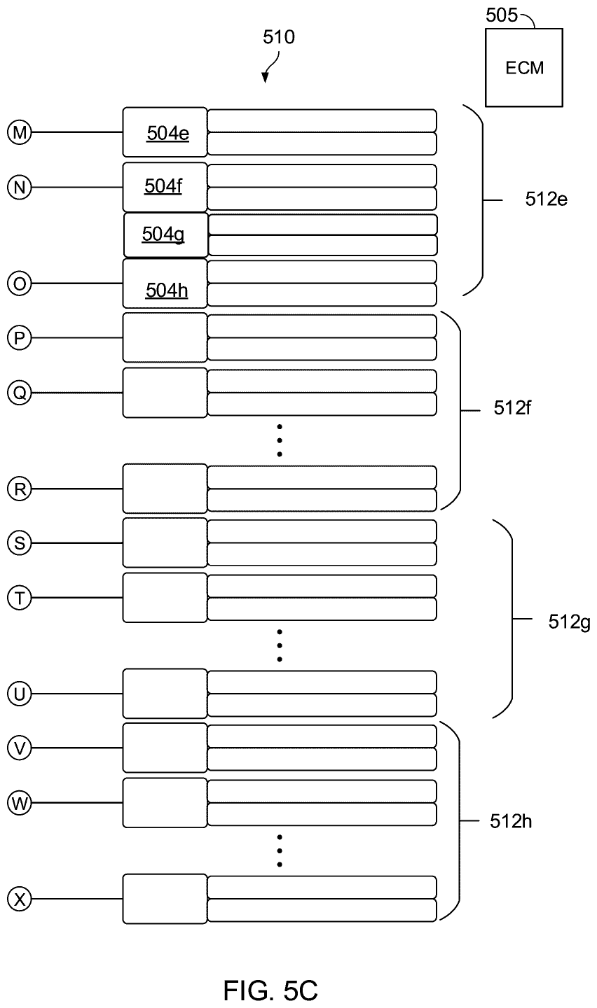

Multiple devices having the basic architecture described above can be combined to create more complex devices. For example, FIGS. 5A, 5B, and 5C depicts a switch 500 that includes the integrated photonic device 100 of FIG. 1 or the integrated photonic device 400 of FIGS. 4A and 4B. FIGS. 5A, 5B, and 5C depict different portions of the switch 500, with FIGS. 5A and 5B connecting at the points A, B, C, D, E, F, G, H, I, J, K, and L and FIGS. 5B and 5C connecting at the points M, N, O, P, Q, R, S T, U, V, W, and X.

The switch 500 is a three-stage, cascaded switch that includes switches 502, e.g., integrated photonic device 100 and/or 400, and processors 504. For example, each switch 502 can be a 16-ported wavelength division multiplexing (WDM), 32-radix switch. In some implementations, the switch 500 can be scaled to 64, 256, 512, or 1024 ported switches. The switch 500 includes a control plane 503 on distributed computing nodes that feed into a switch 507, e.g., a 16-ported optical switch. Optical fibers 506 connects the switch 507 to a corresponding switch 502 in each stage. An electronic control module 505 is connected to the switches 502 and controls the states of the filters within each switch 502.

The switches 502 are arranged in three stages, e.g., stage I, stage II, and stage III. Stage I includes switches 502a, 502b, 502c, and 502d, stage II includes switches 502e, 502f, 502g, and 502h, and stage III includes switches 502i, 502j, 502k, and 502l. One switch in each of the three stages is connected to switch 507 through an optical fiber 506. In stage I, each switch 502 is connected to four processors 504 via fibers 506, each processor 504 having an input/output (IO) port 508. The processors 504 modulate data that is input into the switches 502a-502d. Similarly, in stage III, each switch 502 is connected to four processors 504 via fibers 506, each processor 504 having an input/output (IO) port 508. The processors 504 modulate data that is input into the switches 502i-502l. For example, the processors 504 can modulate data at a rate between 128 Gbps to 512 Gbps. Each processor 504 includes four GPU ports 510. Each processor 504, e.g., a graphics processing unit (GPU), can have an input/output (I/O) bandwidth of 2 Tbps in both directions, e.g., bidirectionally. Overall, the switch 500 can have a configuration time of less than 100 μs.

In stage I, each switch 502a, 502b, 502c, and 502d is connected to each of the switches 502e, 502f, 502g, and 502h in stage II via optical fibers 506. In stage II, each switch 502e, 502f, 502g, and 502h is connected to each of the switches 502i, 502j, 502k, and 502l in stage III.

A cluster 512 refers to the combination of a switch 502 with respective processors 504. For example, cluster 512a includes switch 502a and processors 504a, 504b, 504c, and 504d. In some implementations, e.g., depending on how the filters within the switches 502 are tuned, cluster 512a can direct its entire bandwidth, e.g., read and write traffic, to any other single cluster, e.g., cluster 512e including switch 502i and processors 504e, 504f, 504g, and 504h. In some implementations, cluster 512a can direct its entire bandwidth uniformly across four other clusters, e.g., clusters 512e, 512f, 512g, and 512h. In some implementations, cluster 512a can direct its entire bandwidth uniformly across the remaining clusters, e.g., the seven clusters 512b, 512c, 512d, 512e, 512f, 512g, and 512h. In some implementations, directing bandwidth from one cluster to one or more clusters can occur within a few hundred microseconds.

Subcomponents of clusters 512b, 512c, 512d, 512f, 512g, 512h are not labeled to avoid visual clutter, but these subcomponents are substantially similar to those of clusters 512a and 512e.

In some implementations, filters within each switch 502 can be “tuned out,” e.g., controlled by the ECM 505 to change the resonant frequency of the filter, which effectively closes the port to the switch 502 and disconnects the switch 502. As a result, the network topology of the switch 500 can depend on the operational parameters of the ECM 505.

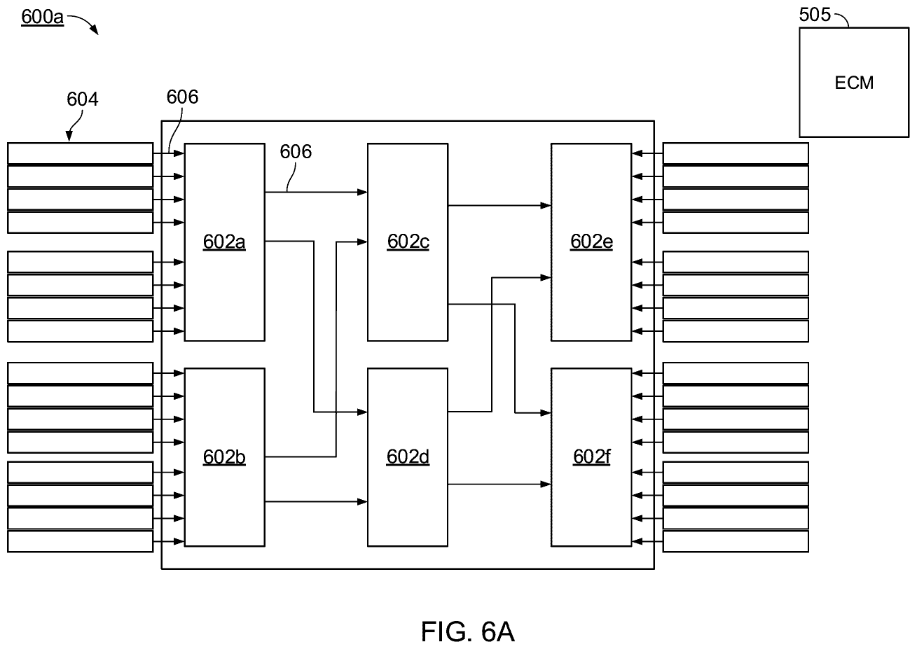

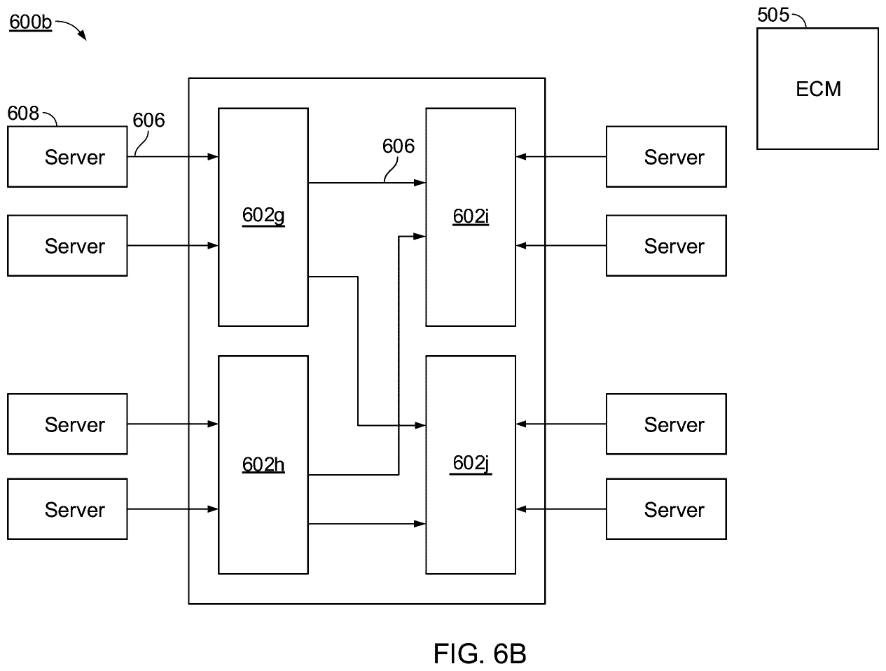

With reference to FIG. 6A, other devices that include the switches as described above are possible. For example, switch 600a can be a server or workstation using general-purpose computing on graphics processing units (GPGPU) specialized for deep learning applications. The switch 600a can be a 128-ported, 128-radix switch that includes 64-ported switches, e.g., devices 100 and/or 400.

Similarly to switch 500, the switch 600a includes switches 602 arranged in three stages. Stage I includes switches 602a and 602b, stage II includes switches 602c and 602d, and stage III includes switches 602e and 602f. Each of the switches 602a, 602b, 602e, and 602f in stages I and III are connected to eight processors 604 via fibers 606. Each processor 604 includes four ports, which can modulate data at a rate of 8 Tbps. An electronic control module 505 controls the states of the filters within each switch.

Each of switches 602a and 602b in stage I are connected to each of switches 602c and 602d in stage II via a fiber 606 that can support 16 channels. Each switch 602c and 602d in stage II is connected to each switch 602e and 602f in stage III via fibers 606 that can support 16 channels. In some implementations, the connection between stages is unidirectional, e.g., from stage I to II and from stage II to III.

Due to the arrangement of the switches in stages including a middle “steering” layer, e.g., switches 602c and 602d, the number of switches that enable each input switch, e.g., switches 602a and 602b, to communicate with each output switch, e.g., switches 602e and 602f, is relatively low. For example, other systems that enable “all-to-all” communication between switches generally use at least 2n−1 switches, where n is the number of import ports on the switch. However, in switch 600a, all-to-all communication is enabled with only n switches.

Additionally, arrangements exemplified by switch 600a enable concurrent communication between switches in different stages. For example, switch 602a can send optical signals to switches 602e and 602f at the same time. Each of the paths, e.g., following optical fibers 606 between the stages, from switch 602a to switch 602e and from switch 602a to switch 602f is unique.

Another benefit is the ability to perform broadcasting using such switch arrangements. For example, switch 600a can include a control plane, e.g., similar to control plane 503, that is configured to, while switch 602a broadcasts the same optical signal to switches 602e and 602f, prevent switch 602b from sending optical signals to switches 602e and 602f.

With reference to FIG. 6B, a switch 600b can be a 256-ported, 256-radix switch that includes 128-ported switches, e.g., devices 100 and/or 400. The switch 600b includes switches 602g and 602h in stage I and switches 602i and 602j in stage II. Each switch 602 in one stage is connected to both switches in the other stage via optical fibers 606 that can support 32 channels. In some implementations, the connection between stages is unidirectional, e.g., from stage I to II. Switches 602g-602j are each connected to two servers 608, e.g., a DGX server from Nvidia (Santa Clara, CA). Each of the servers 608 is connected to a respective switch 602 via optical fiber 606 can support 32 channels. An electronic control module 505 controls the states of the filters within each switch.

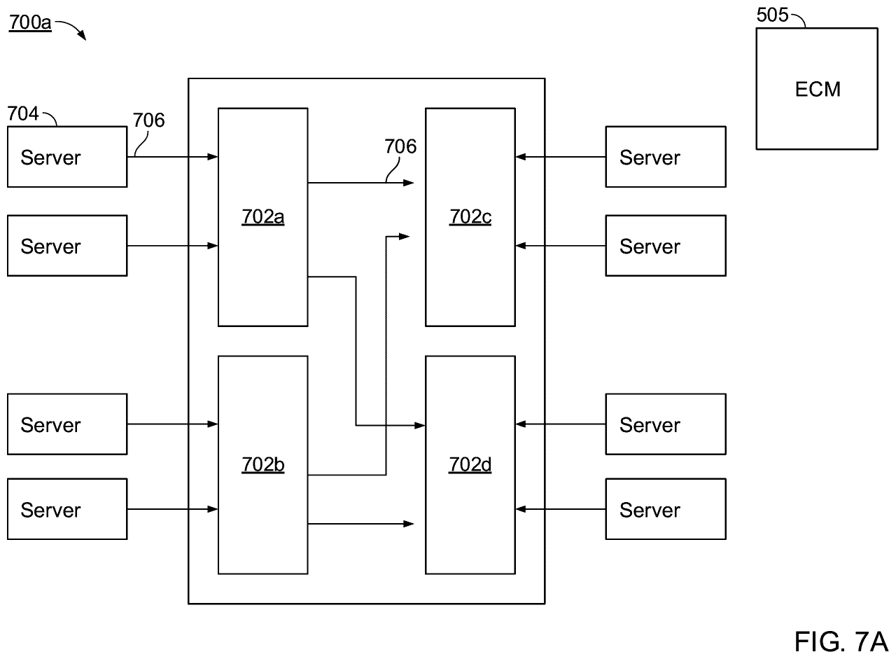

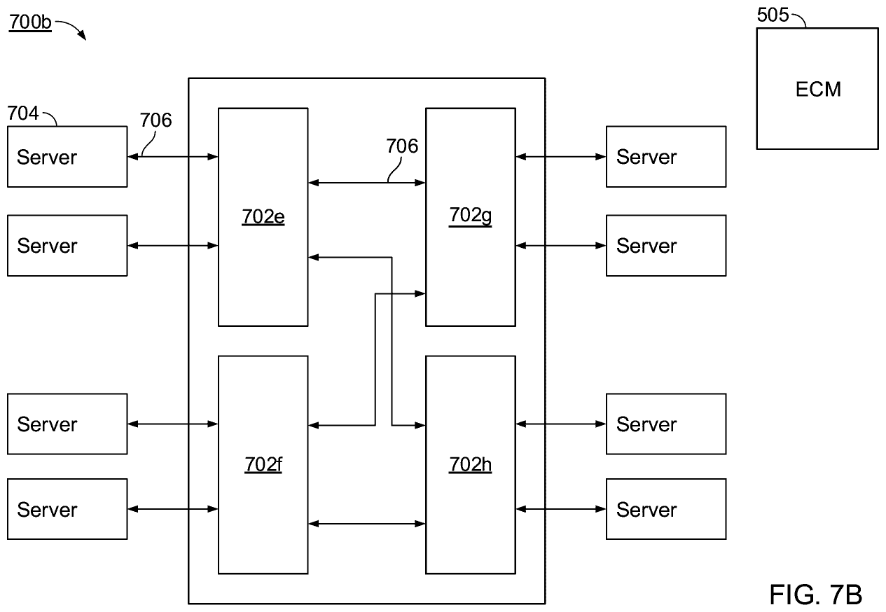

With reference to FIG. 7A, a switch 700a can be a 512-ported, 512-radix switch that includes 256-ported switches, e.g., devices 100 and/or 400. The switch 700a includes switches 702a and 702b in stage I and switches 702c and 702d in stage II. An electronic control module 505 controls the states of the filters within each switch. Each switch 702 in one stage is connected to both switches in the other stage by the optical fibers 706 that can support 64 channels. Each switch 702 is connected to two servers 704, e.g., dual DGX servers. In some implementations, the connection between stages is unidirectional, e.g., from stage I to II.

With reference to FIG. 7B, a switch 700b can be a 1024-ported, 1024-radix switch that includes 512-ported switches, e.g., devices 100 and/or 400. The switch 700b includes switches 702e and 702f in stage I and switches 702g and 702h in stage II. An electronic control module 505 controls the states of the filters within each switch. Each switch 702 in one stage is connected to both switches in the other stage by optical fibers 706 that can support 128 channels.

In some implementations, the connection between stages is bidirectional, e.g., either from stage I to II or from stage II to I. Each switch 702e-702h is connected to a server 704, e.g., a quad DGX server by an optical fiber 706 I can support 128 channels. The connection between the switches 702e-702h and the servers 704 can be bidirectional.

Switches 500, 600a, 600b, 700a, and 700b can be used in a variety of applications. For example, switches 700a and 700b can be particularly well suited for large language models (LLM). For example, traffic between nodes in a LLM is deterministic and tend to have high bandwidth requirements that can rapidly change over time, e.g., within a few hundred microseconds or milliseconds. As demonstrated in the examples in FIGS. 5A, 5B, 5C, 6A, 6B, 7A, and 7B, high-radix switches, e.g., having a radix of 512 or higher, can be constructed from lower-radix switches, e.g., such as switches formed by integrated photonic devices 100 and 400. The switches 500, 600a, 600b, 700a, and 700b can be rapidly configured, e.g., on the order of microseconds, to support various bandwidths between different clusters. The ECM 505 controls the configuration of each of switches 500, 600a, 600b, 700a, and 700b.

In some implementations, the switching power can be relatively low, e.g., tens of Watts, compared with conventional, higher-radix switches that demand thousands of Watts. Additionally, latency between clusters within switches 500, 600a, 600b, 700a, and 700b can be less than 500 nanoseconds, which is relatively low compared to a typical higher-radix switch with latencies of about a few hundred microseconds or tens of milliseconds.

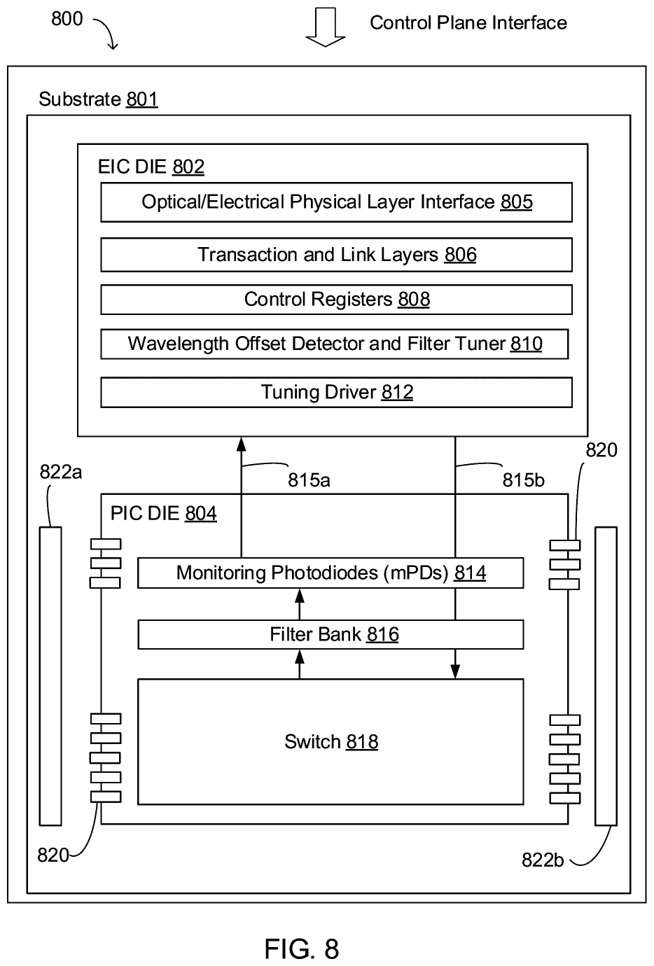

The disclosed switches can be incorporated into a variety of devices. For example, with reference to FIG. 8, an example device 800 includes an electronic integrated circuit (EIC) die 802 and a photonic integrated circuit (PIC) die 804 supported by a substrate 801. Wire bonds or other types of electrical connections can electronically couple the PIC and EIC dice 802 and 804 to the substrate 801.

The EIC die 802 interfaces with a control plane and programs a PIC on the PIC die 804, which performs photonic switching operations. Depending on the light sources for the PIC die 804, there can be slight wavelength mismatches between the wavelengths of the received optical signals and the operational wavelength ranges of the switch within the PIC of the PIC die 804. For example, each operational wavelength range can have a peak wavelength and a spread of nonzero amplitudes around the peak wavelength, e.g., a finite bandwidth. The switch 818 is configured to perform a switching operation after receiving an optical signal including a component within one of the operational wavelength ranges having an amplitude above a threshold value.

The EIC die 802 includes an optical/electrical physical layer interface 805, transaction and link layers 806, and control registers 808, connected to each other through electronic circuitry. The optical/electrical physical layer interface 805 can have a chip form factor and provide an optical and an electrical interface between the EIC die 802 and an external control plane processor, e.g., or a central processing unit (CPU), host, or computer that runs control plane software. The external control plane software can calculate the source to destination paths and configure the switch 818 through the interface 805. The transaction and link layers 806 can implement industry standard protocols such as peripheral component interconnect (PCI) and compute express link (CXL). Other UFX protocols can also be used. For example, the transaction and link layers 806 can follow a peripheral component interconnect (PCI) packet-based protocol to communicate between the optical/electrical physical layer interface 805 and the control registers 808. The control registers 808 can be configuration space registers, which are mapped into the control plane processor's memory as memory mapped input/output (MMIO).

To address the wavelength mismatch, the EIC die 802 also includes a wavelength offset detector and filter tuner 810 and a tuning driver 812. The wavelength offset detector and filter tuner 810 include circuitry to determine, based on a value of a current, a wavelength offset of an input wavelength to the PIC die 804 compared to an expected value. Using the determined wavelength offset, the wavelength offset detector and filter tuner 810 can determine control signals to send to the PIC die 804 to tune the operational wavelength of the receive (RX) filters within the PIC die 804. The tuning driver 812 communicates with the control registers 808 to send instructions, based on the control signals generated by the wavelength offset detector and filter tuner 810, to the PIC die 804.

The PIC die 804 includes monitoring photodiodes (mPDs) 814, filter bank 816, switch 818, input ports 820, and fiber array units 822, which are optically coupled to each other, e.g., through waveguides. As will be explained below, the mPDs 814 generate an electronic signal to send to the EIC die 802, and components of the switch 818 are controlled by instructions received from the EIC die 802. For example, the EIC die 802 can control the switch 818 similarly to how ECM 205 controls add-drop filters 200a and 200b.

The fiber array units 822 can have different sources for optical signals. For example, fiber array unit 822a can connect to fibers from a graphics processing unit (GPU), and fiber array unit 822b can connect to fibers from a dual in-line memory module (DIMM). Standard multi-sourcing agreement (MSA) specifications allow for slight variation in the wavelength for different grid spacings. That slight variation, however, can negatively impact the performance of the switch 818.

The device 800 can lock the grid, e.g., reduce wavelength mismatch, by implementing a closed loop control system for tuning the filters in switch 818 and filter bank 816. In some implementations, the switch 818 is one of the devices 100 and 400, switches 500, 600a, 600b, 700a, and 700b, or any PIC switch based on wavelength demultiplexing, e.g., a Mach-Zehnder modulator.

For proper operation of the switch, the input wavelength grid, e.g., evenly spaced wavelengths in a grid, of each input port 820 are aligned to the corresponding wavelength grid used by the switch 818. When wavelengths are misaligned, a filter will not drop or detect a specific wavelength, since the specific wavelength doesn't have a high enough amplitude. The filter bank 816 includes multiple filters that receive the same input optical signals as the switch 818 and operate as a cascaded optical bandpass filter.

The filter bank 816 includes at least one filter in the that is aligned to the grid, e.g., filters optical signals with the expected frequencies, and at least two filters that are aligned to be slightly offset from the grid, e.g., plus and minus frequency directions relative to the expected frequencies. More filters can be added at different offsets to get more information.

As an example, an optical bandpass filter only transmits optical signals in certain frequency ranges by filtering out components of an optical signal outside of these frequency ranges. The filter bank 816 samples the spectrum of the input optical signal and determines a grid offset deterministically when a switching operation is performed. This grid offset indicates whether the optical signals from the fiber array units 822 included components are straying from the expected frequency components. The bandpass response, e.g., the filtered response, can be data representing an amplitude of the received optical signal versus frequency of the transmitted optical signal.

In some implementations, the filters filter different equally spaced wavelength bands defined by the allowed central wavelength drift range on both sides as defined by the course wavelength division multiplexing (CWDM) MSA. Optionally, the PIC die 804 can include a wavelength selector on each input port 820 to detect what the grid spacing from each light source coupled to an input port 820 is. This way, if an upstream switch, e.g., switch 818, changes routing configuration, causing the grid spacings of the incoming optical signal and switch 818 to differ, the switch 818 can use the detected grid spacing to quickly and deterministically adjust some physical settings to align properly to the grid spacing of the incoming optical signal from an input port 820. In some implementations, the wavelength selector only measures the optical amplitude over a small range of wavelengths, e.g., a sampling of three or more wavelengths within one channel spacing of the defined grid, so the wavelength selector diminish the amplitude of the input optical signals too much, e.g., less than is necessary to act as an electro-optic receiver.

In some implementations, each filter's bandwidth can be selected to provide a 50% overlap with the bandwidths of adjacent filters. This way, if any of the filters outputs a response with a central peak having a maximum, preset value, then the wavelength of the incoming optical signal can be detected accurately. If two adjacent filters respond with equal amplitudes of the central peak of the optical signal, this indicates that the incoming optical signal has a wavelength located half-way between the two central peaks. If a first filter's amplitude of the peak response is 25% of the preset maximum value, and a second, adjacent filter has an amplitude of the peak response of 75% of the preset maximum value, then the incoming wavelength is a weighted average of the wavelength of the peaks, where the weights are 25% and 75%.

Monitoring photodiodes 814 receive the filtered optical response and generate an electrical signal. For example, the monitoring photodiodes 814 “measure” the bandpass response of the filter bank 816 by generating a current based on the amplitudes of the different frequency components of the filtered optical signal. Through wire bonds 815a, the monitoring photodiodes 814 sends the generated current to the EIC die 802. The wavelength offset detector and filter tuner 810 use the value of the generated current to determine the wavelength offset. Using the wavelength offset, the tuning driver 812 updates control signals, such as temperatures of heaters used on micro ring resonators with the switch 818. The tuning driver 812 generates instructions to send to the PIC die 804. Through another wire bonds 815b, the EIC die 802 sends the instructions to the switch 818.

The degree of wavelength tuning can depend on grid spacing. For example, the grid spacing can be 100 GHz, 200 GHz, or 400 GHz, where 1 nm approximately corresponds to 200 GHz. The scale of tuning can be up to half of the spacing in the grid, e.g., about 1 nm. Advantageously, this tuning is grid-spacing agnostic, as in the tuning can be used for a variety of grid spacings, if the frequency spacing is regular.

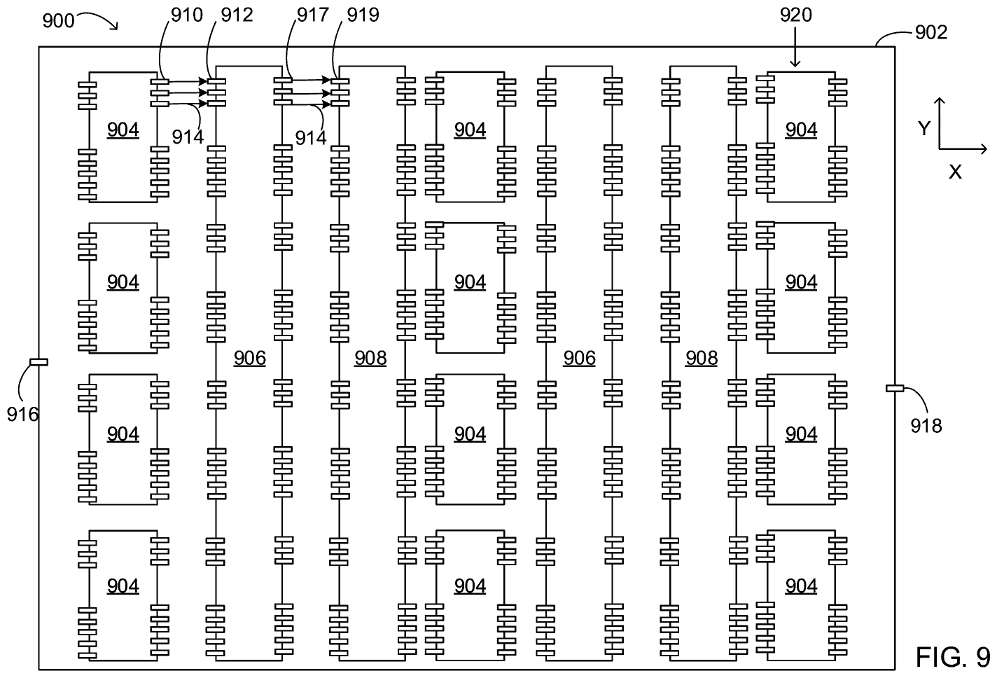

With reference to FIG. 9, devices such as device 800 can be incorporated into larger systems to build higher radix switches. For example, subsystem 900 is a building block of a larger system, where several low radix switches, e.g., devices 800, are used to create a larger radix switch on a glass or silica substrate. Subsystem 900 includes a planar lightwave circuit (PLC) glass or silica substrate 902 supporting switch dies 904, and semiconductor optical amplifier (SOA) dies 908 connected via waveguides 906 that are etched in the substrate 902. The light from a switch die 904 and a SOA die 908 is coupled into the waveguide 906 on the substrate 902 using butt- or evanescent-coupling. In another variant, subsystem 900 includes switch dies 904, SOA dies 908, and waveguides 906, all of which are enclosed in a package mounted on a PCB substrate and connected via fibers. Fibers 914 connect each of the switch dice 904, waveguide die 906, and semiconductor optical amplifier (SOA) dice 908 to each other.

In some implementations, the substrate 902 is a printed circuit board, a ceramic substrate, or a glass substrate; the switch die 904 can include a silicon photonic (SiPho) substrate; the waveguide die 906 can include glass or silicon PLCs, SiPho die, or ion exchanged glass; and the SOA die 908 can include an indium phosphide (InP) substrate.

The switch dice 904 are organized in an array, e.g., a matrix formed by multiple subarrays. For example, the array of switch dice 904 includes three subarrays 920, e.g., columns extending along the Y direction, of switch dice 904 arranged in a direction perpendicular to the direction in which the subarrays 920 extend, e.g., the X direction.

In the arrangement of subsystem 900, different types of die can be connected by the waveguide die 906. For example, multiple switch dice 904 are connected to SOA dice 908 via the waveguide dice 906. In subsystem 900, a waveguide die 906 and a SOA die 908 are located between each pair of subarrays 920 of the switch dice 904.

Fibers 914 connect output optical ports 910 of switch dice 904 to a respective input optical port 912 of the waveguide dice 906, as well as connecting output optical ports 917 of the waveguide dice 906 to input optical ports 919 of SOA dice 908. In some implementations, the fibers 914 perform input to output fixed path routing. Additionally, or alternatively, some fibers 914 can be replaced with a PLC or photonic wire bonding.

The SOA dice 908 compensate for insertion loss resulting from routing signals from one switch die to another. If the insertion loss between switch dice 904 is below a threshold value, the SOA dice 908 can be omitted from subsystem 900, and the waveguide die 906 can connect various types of die.

Accordingly, heterogeneous architectures, e.g., mixing different types of die, are possible, thereby enabling scalability of complex systems. Various topologies can be implemented using the combination of the switch dice 904, the waveguide dice 906, and the SOA dice 908.

Further scaling is possible. As an example, the subsystem 900 can be connected to other subsystems using fiber connections to form a system, e.g., via fiber input port 916 and fiber output 918 for the subsystem 900. The system can be connected to other systems and supported by a rack unit, and multiple rack units can be connected. With regards to size, the length and width of the substrate 902 can be on the order of hundreds of millimeters, e.g., 200 mm×200 mm. In some implementations, a system composed of multiple subsystems 900 can have up to 1024, 2048, 4096, 8192 or 16K ports. Multiple substrates can fit on one or more rack unit form factor.

In the physical layout of subsystem 900, the fibers 914 between the input and output ports 912 and 910 have a 1:1 relationship. For example, there are as many output ports 910 as there are input ports 912, and there is a single fiber 914 connecting each pair of input and output ports 912 and 910. So, there are as many fibers as there are pairs of input and output ports. The fibers 914 between the input and output ports 919 and 917 have a 1:1 relationship.

Further, the fibers 914 can be arranged in straight lines, e.g., have a straight form factor with no crossing or bends. This sort of arrangement can increase device density. The package sizes are selected such that fibers 914 can be actively aligned between input and output ports with or without splicing.

In addition to the embodiments of the attached claims and the embodiments described above, the following embodiments are also innovative.

In general, aspects of the subject matter described in this specification can be embodied in an integrated photonic device for independently directing each channel of a multiplexed input optical signal received from a corresponding one of N input port to one of N output ports, each multiplexed input optical signal including N channels, the device including: N input waveguides each optically coupled to a corresponding one of the N input ports and arranged to guide one of the multiplexed input optical signals from the corresponding input port; secondary waveguides for guiding demultiplexed optical signals each in one of the N channels; wavelength-selective filters, each: i) including a ring resonator, ii) being optically coupled to a corresponding one of the N input waveguides and a corresponding one of the secondary waveguides, and iii) being switchable between a first state in which an optical signal in a corresponding one of the N channels is coupled from the corresponding input waveguide into the corresponding secondary waveguide and a second state in which the optical signal in the corresponding one of the N channels is not coupled into the corresponding secondary waveguide; N multi-wavelength mixers each configured to receive to optical signals from N of the secondary waveguides and each configured combine the received optical signals from the N secondary waveguides into a single multiplexed output optical signal; and N output waveguides each coupled to a respective one of the multi-wavelength mixers and configured to receive the multiplexed output optical signal from the respective multi-wavelength mixer.

Another general aspect can be embodied in a system that includes: switches arranged in two or more stages; processors; and an additional switch coupled to a single switch in each stage of the three stages via optical fibers. Each switch can be the device of the previous aspect. Switches in a same stage of the at least two stages can be configured to send optical signals to any switch in another stage. Each switch can be connected to at least two processors of the processors that are configured to modulate optical signals.

Another general aspect can be embodied in an optical switching method for routing multiplexed optical signals using a photonic integrated circuit. The method includes: receiving, at the photonic integrated circuit, N multiplexed input optical signals each comprising N channels; transmitting, by a corresponding one of N input waveguides in the photonic integrated circuit, each of the N multiplexed input optical signals to N serially-arranged, optical filters in the photonic integrated circuit; activating, according to routing information, one of the N serially-arranged, optical filters for each input waveguide to couple a different one of the N channels into corresponding secondary waveguides in the photonic integrated circuit; and combining, at N multi-wavelength mixers in the photonic integrated circuit, optical signals from N of the corresponding secondary waveguides, to form N multiplexed output optical signals.

Another general aspect can be embodied in a method that includes: receiving, from a wavelength demultiplexing switch and by an array of optical filters configured to transmit optical signals in multiple operational wavelength ranges, multiple optical signals of one or more wavelengths; generating, by the array of optical filters, a filtered optical signal; generating, by one or more monitoring photodiodes optically coupled to the array of optical filters, an electronic current based on the filtered optical signal; determining, using the electronic current, one or more wavelength offsets between the one or more wavelengths and the multiple operational wavelength ranges of the switch; and determining control signals for the switch based on the wavelength offsets.

Another general aspect can be embodied in device including: a substrate; an array of switch packages arranged in multiple columnar subarrays, each switch package comprising multiple optical input ports and multiple optical output ports; an array of semiconductor optical amplifier packages, each semiconductor optical amplifier package comprising multiple input ports and multiple output ports; an array of waveguide packages, each waveguide package comprising multiple input ports and multiple output ports and located between a columnar subarray of switch packages and a semiconductor optical amplifier package; first optical fibers configured to connect output ports of a first switch package of the array of switch packages to input ports of a first waveguide package the array of waveguide packages; second optical fibers configured to connect output ports of the first waveguide package to input ports of a first semiconductor optical amplifier package of the array of semiconductor optical amplifier packages; and third optical fibers configured to connect output ports of the first semiconductor optical amplifier package to input ports of a second switch package of the array of switch packages. Each of the first, second, and the third optical fibers include the same number of fibers, and the same number is the number of output ports the first switch package.

These and other implementations can each optionally include one or more of the following features.

In some implementations, N wavelength-selective filters of the wavelength-selective filters are optically coupled to each of the N input waveguides, each of the N wavelength-selective filters being configured to couple a different one of the N channels from the corresponding input waveguide into a secondary waveguide.

In some implementations, the wavelength-selective filters are arranged in N filter arrays, each filter array coupling the N input waveguides to a corresponding one of the multi-wavelength mixers via N of the secondary waveguides.

In some implementations, each filter array is an N×N array, and each column of the filter array corresponds to an input waveguide and each row of the filter array corresponds to a secondary waveguide.

In some implementations, in the first state, the wavelength-selective filters are configured to direct light from one column to another column of the filter array in the first state, and, in the second state, the wavelength-selective filters are configured to direct light from one row to another row of the filter array.

In some implementations, adjacent filter arrays of the N filter arrays are connected to each other by the rows of the array, thereby forming a N²×N super array.

In some implementations, each row of an individual filter array includes one and no more than one wavelength-selective in the first state for a different one of the N channels.

In some implementations, for every N wavelength-selective filter of the wavelength-selective filters, one wavelength-selective filter is configured to selectively filter one channel of N channels and N−1 wavelength-selective filters are configured to not selectively filter the one channels.

In some implementations, there are N² wavelength-selective filters of the wavelength-selective filters.

In some implementations, the device further includes channel mixers each associated with a corresponding one of the multi-wavelength mixers, each channel mixer being configured to receive optical signals in one of the N channels from each of the input waveguides via a corresponding secondary waveguide.

In some implementations, there are N² channel mixers of the channel mixers.

In some implementations, the wavelength-selective filters are arranged in N²+N filter arrays, each filter array including N wavelength-selective filters.

In some implementations, N of the filter arrays are first filter arrays, and each wavelength-selective filter in each of the first filter arrays is in the first state for a corresponding channel of the N channels.

In some implementations, N² of the filter arrays each include N wavelength-selective filters. Only one wavelength-selective filter of the N wavelength-selective filters can be in the first state.

In some implementations, each filter array has N rows, and each row connects N+1 wavelength-selective filters in the same row and includes exactly two wavelength-selective filters in the first state.

In some implementations, there are at least N³+N² of the wavelength-selective filters.

In some implementations, the N channels are equally spaced apart in wavelength.

In some implementations, the device further includes one or more heaters coupled to the wavelength-selecting filters and in electrical communication with control circuitry. The control circuitry can be configured to tune resonant frequencies the multiple wavelength-selecting filters by adjusting a temperature of the one or more heaters.

In some implementations, a first switch of the switches has a bandwidth, and, in a first configuration, the first switch is configured to send an entirety of the bandwidth to a second switch of the switches, and in a second configuration, and the first switch is configured to uniformly send the bandwidth to N−1 other switches of the switches.

In some implementations, the method further includes coupling, by N input ports, the N multiplexed input optical signals to respective input waveguides of the N input waveguides.

In some implementations, the method further includes maintaining an inactivated state of an additional optical filter coupled to the N serially-arranged, optical filters.

In some implementations, the method further includes guiding, by one of the N input waveguides, a multiplexed optical signal of the N multiplexed input optical signals, past the additional optical filters in the inactivated state.

In some implementations, the method further includes changing, according to new routing information and by at least one of heater or a cooler, a temperature of at least one of the N optical filters In some implementations,

In some implementations, generating the new routing information on microsecond intervals.

In some implementations, coupling, by each input waveguide, the different one of the N channels into the corresponding secondary waveguides includes: in-coupling the different one of the N channels from each input waveguide into a ring resonator; and out-coupling the different one of the N channels to the secondary waveguide.

In some implementations, the ring resonator is a first ring resonator, and coupling further includes: coupling the different one of the N channels from the first ring resonator to a second ring resonator; and out-coupling the different one of the N channels from the second ring resonator to the secondary waveguide.

In some implementations, the method further includes: coupling, by the corresponding secondary waveguides, the optical signals into additional input waveguides; and coupling, by the additional input waveguides, the optical signals into N² additional optical filters.

In some implementations, the method further includes receiving, by N² channel mixers, the optical signals from the N² additional optical filters.

In some implementations, the method further includes receiving, by the N multi-wavelength mixers, the optical signals from the N² channel mixers.

In some implementations, receiving, by the N² channel mixers, the optical signals from the N² additional optical filters includes adding one optical signal per N optical signals of the optical signals to one of N ring resonators of a corresponding channel mixer.

In some implementations, the method further includes dropping, by the one ring resonator of the corresponding channel mixer, the one optical signal into an additional secondary waveguide coupled to a respective multi-wavelength mixer of the multi-wavelength mixers.

In some implementations, the method further includes modulating, by N processors optically coupled to the N input waveguides, optical signals to form the N multiplexed input optical signals.

In some implementations, the method further includes coupling, via an output waveguide coupled to corresponding N multi-wavelength mixers, the N multiplexed output optical signals from the N multi-wavelength mixers to a single optical switch.

In some implementations, the method further includes coupling, via an output waveguide coupled to corresponding N multi-wavelength mixers, the N multiplexed output optical signals from the N multi-wavelength mixers to N optical switches, respectively.

In some implementations, the method further includes disconnecting at least one optical switch of the N optical switches from the output waveguide.

In some implementations, disconnecting the at least one optical switch from the N multi-wavelength mixers includes thermally tuning the at least one optical switch.

In some implementations, the method further includes receiving, by the photonic integrated circuit and at a first time, multiplexed optical signals from an optical switch.

In some implementations, the method further includes, at a second time, transmitting at least a portion of the N multiplexed output optical signals to another optical switch. A difference between the first and second times can be less than 500 nanoseconds.

In some implementations, the control signals include electronic signals for controlling a temperature of each of a corresponding micro ring resonator of the one or more micro ring resonators within the switch.

In some implementations, the multiple operational wavelength ranges of the switch are equally spaced in wavelength.

In some implementations, the switch is configured to direct each channel of a multiplexed input optical signal received from a corresponding one of N input port to one of N output ports, each multiplexed input optical signal including N channels. The switch includes: N input waveguides each optically coupled to a corresponding one of the N input ports and arranged to guide one of the multiplexed input optical signals from the corresponding input port; multiple secondary waveguides for guiding demultiplexed optical signals each in one of the N channels; multiple wavelength-selective filters, each: including a ring resonator, being optically coupled to a corresponding one of the N input waveguides and a corresponding secondary waveguide of the multiple secondary waveguides, and being switchable between a first state in which an optical signal in a corresponding one of the N channels is coupled from the corresponding input waveguide into the corresponding secondary waveguide and a second state in which the optical signal in the corresponding one of the N channels is not coupled into the corresponding secondary waveguide; N multi-wavelength mixers each configured to receive to optical signals from N of the secondary waveguides and each configured combine the received optical signals from the N secondary waveguides into a single multiplexed output optical signal; and N output waveguides each coupled to a respective one of the multi-wavelength mixers and configured to receive the multiplexed output optical signal from the respective multi-wavelength mixer.

In some implementations, an output port of each device is connected to an input port of another device via an optical fiber.

In some implementations, the substrate includes a printed circuit board, a ceramic layer, or a glass layer.

In some implementations, the array of waveguide packages includes one of a planar lightwave circuit, a silicon photonics die, and ion exchanged glass.

In some implementations, the semiconductor optical amplifier package includes an indium phosphide substrate.

In some implementations, the first, second, and third optical fibers have a straight form factor.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results.

What is claimed is:

1. A device comprising:
a substrate;
an array of switch packages arranged in a plurality of columnar subarrays, each switch package comprising multiple optical input ports and multiple optical output ports;
an array of semiconductor optical amplifier packages, each semiconductor optical amplifier package comprising multiple input ports and multiple output ports;
an array of waveguide packages, each waveguide package comprising multiple input ports and multiple output ports and located between a columnar subarray of switch packages and a semiconductor optical amplifier package;
a first plurality of optical fibers configured to connect output ports of a first switch package of the array of switch packages to input ports of a first waveguide package the array of waveguide packages;
a second plurality of optical fibers configured to connect output ports of the first waveguide package to input ports of a first semiconductor optical amplifier package of the array of semiconductor optical amplifier packages; and
a third plurality of optical fibers configured to connect output ports of the first semiconductor optical amplifier package to input ports of a second switch package of the array of switch packages,
wherein each of the first, second, and third plurality of optical fibers comprise the same number of fibers, and the same number is a number of output ports the first switch package.

2. A system comprising a plurality of the devices of claim 1, wherein an output port of each device is connected to an input port of another device via an optical fiber.

3. The device of claim 1, wherein the substrate comprises a printed circuit board, a ceramic layer, or a glass layer.

4. The device of claim 1, wherein the array of waveguide packages comprises one of a planar lightwave circuit, a silicon photonics die, and ion exchanged glass.

5. The device of claim 1, wherein the semiconductor optical amplifier package comprises an indium phosphide substrate.

6. The device of claim 1, wherein the first, second, and third pluralities of optical fibers have a straight form factor.

7. The device of claim 1, wherein each switch package comprises N input ports and N output ports, and each switch package is configured to direct each channel of a multiplexed input optical signal received from a corresponding one of N input ports to one of N output ports, each multiplexed input optical signal comprising N channels.

8. The device of claim 7, wherein each switch package comprises N input waveguides each optically coupled to a corresponding one of the N input ports and arranged to guide one of the multiplexed input optical signals from the corresponding input port.

9. The device of claim 8, wherein each switch package comprises a plurality of secondary waveguides for guiding demultiplexed optical signals each in one of the N channels.

10. The device of claim 9, wherein each switch package comprises a plurality of wavelength-selective filters, each:
i. comprising a ring resonator,
ii. being optically coupled to a corresponding one of the N input waveguides and a corresponding secondary waveguide of the plurality of secondary waveguides, and
iii. being switchable between a first state in which an optical signal in a corresponding one of the N channels is coupled from the corresponding input waveguide into the corresponding secondary waveguide and a second state in which the optical signal in the corresponding one of the N channels is not coupled into the corresponding secondary waveguide.

11. The device of claim 9, wherein each switch package comprises N multi-wavelength mixers each configured to receive to optical signals from N of the secondary waveguides and each configured combine the received optical signals from the N secondary waveguides into a single multiplexed output optical signal.

12. The device of claim 11, wherein each switch package comprises N output waveguides each coupled to a respective one of the multi-wavelength mixers and configured to receive the multiplexed output optical signal from the respective multi-wavelength mixer.

13. The device of claim 1, wherein the first, the second, and the third pluralities of optical fibers use butt-or evanescent-coupling.

14. The device of claim 1, wherein the plurality of columnar subarrays are spatially aligned such that the array of switch packages form a matrix.

15. The device of claim 1, wherein aa length and a width of the substrate are on the order of hundreds of millimeters.

16. The device of claim 1, wherein a total number of optical input ports in the device is at least 10,000.

17. The device of claim 16, wherein each switch package comprises a same number of optical input ports and optical output ports.

18. The device of claim 16, wherein a total number of optical fibers in the first, second, and third plurality of optical fibers is the same number as the number of optical input ports.

19. The device of claim 1, wherein each waveguide package has more optical input ports than each switch package.

20. The device of claim 19, wherein each waveguide package has a same number of optical output ports as each semiconductor optical amplifier package has input ports.
